(19) United States
(12) Patent Application Publication
(10) Pub. No.: US 2010/0293499 A1
(43) Pub. Date: Nov. 18, 2010

(54) RENDERING TO A DEVICE DESKTOP OF AN ADAPTIVE INPUT DEVICE

(75) Inventors: Robert D. Young, Kirkland, WA (US); Daniel Sangster, Bellevue, WA (US); Stephen Cooper, Seattle, WA (US); Sachin Suresh Hegde, Bellevue, WA (US); Teague Curtiss Mapes, Woodinville, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/466,074

(22) Filed: May 14, 2009

(51) Int. Cl. G06F 3/048; G09G 5/00

(52) U.S. Cl. 715/779; 345/156; 715/234; 715/863; 715/702

(57) ABSTRACT

Embodiments relating to facilitating communication between an adaptive input device and a device desktop application program in a computing system are disclosed. One example embodiment includes a computing system that comprises an device desktop and an adaptive device input/output module that is configured to receive an output command from the device desktop application program; identify an image rendering protocol of the device desktop application program in the device desktop; and create an image of the one or more user interface elements according to the image rendering protocol. The adaptive device input/output module is further configured to forward the image to the adaptive input device for display.

### BACKGROUND

Most modern personal computers run multithreaded operating systems that display a virtual active desktop on a monitor of the personal computer, and enable users to interact with graphical user interfaces of multiple application programs that are displayed in windows viewable on the desktop. When multiple applications are running, user input may be directed from a keyboard to a window that has keyboard focus, such as a topmost window in a stack of windows. Space is finite on the active desktop, and even when multiple monitors are combined to form an extended desktop, users often run out of space to display the information they desire, and may have difficulty keeping track of open windows. Further application developers are confined to display graphical output of application programs on the active desktop, where space is in high demand and competition for keyboard focus from other applications is ever present.

### SUMMARY

Computing systems and methods for facilitating communication between an adaptive input device and a device desktop application program in a computing system are provided. The computing system may include a device desktop managed by an operating system executed by a processor of the computing system, the device desktop being independent from an active desktop of the operating system, and being configured to be displayed across one or more displays of one or more adaptive input devices, and configured to receive user input from corresponding input mechanisms associated with one or more adaptive input devices, the device desktop being configured to host an input device user interface of at least one device desktop application program.

The computing system further comprises an adaptive device input/output module that is configured to receive an output command from the associated device desktop application program. The output command includes instructions and content for presenting one or more user interface elements of the input device user interface. The adaptive device input/output module is further configured to identify an image rendering protocol of the device desktop application program in the device desktop and create an image of the one or more user interface elements according to the image rendering protocol. The adaptive device input/output module is further configured to forward the image to the adaptive input device for display.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic depiction of an example embodiment of a computing system including a computing device and an adaptive input device.

FIGS. 2 and 3 are flowcharts depicting an example embodiment of a method of facilitating communication between an adaptive input device and a device desktop application program managed by an operating system of a computing device.

FIG. 4 is a flowchart depicting an example embodiment of a method of creating an image of one or more user interface elements according to the first image rendering protocol.

FIG. 5 is a flowchart depicting an example embodiment of a method of creating an image of one or more user interface elements according to the second image rendering protocol.

FIG. 6 depicts an example embodiment of an adaptive input device in the context of a computing system.

FIG. 7 depicts an example of input device user interfaces that may be presented via an adaptive input device, such as the adaptive input device depicted in FIG. 6.

### DETAILED DESCRIPTION

The present disclosure provides embodiments relating to an adaptive input device that may be used to provide user input to a computing device. The adaptive input device described herein may include one or more physical and/or virtual controls that a user may manipulate to provide a desired user input. The adaptive input device is capable of having its visual appearance periodically changed by application programs operating on the computing device. As a non-limiting example, a device desktop application program may be configured to cause the adaptive input device to change the visual appearance of its one or more depressible buttons or touch-sensitive surfaces to thereby improve the user experience.

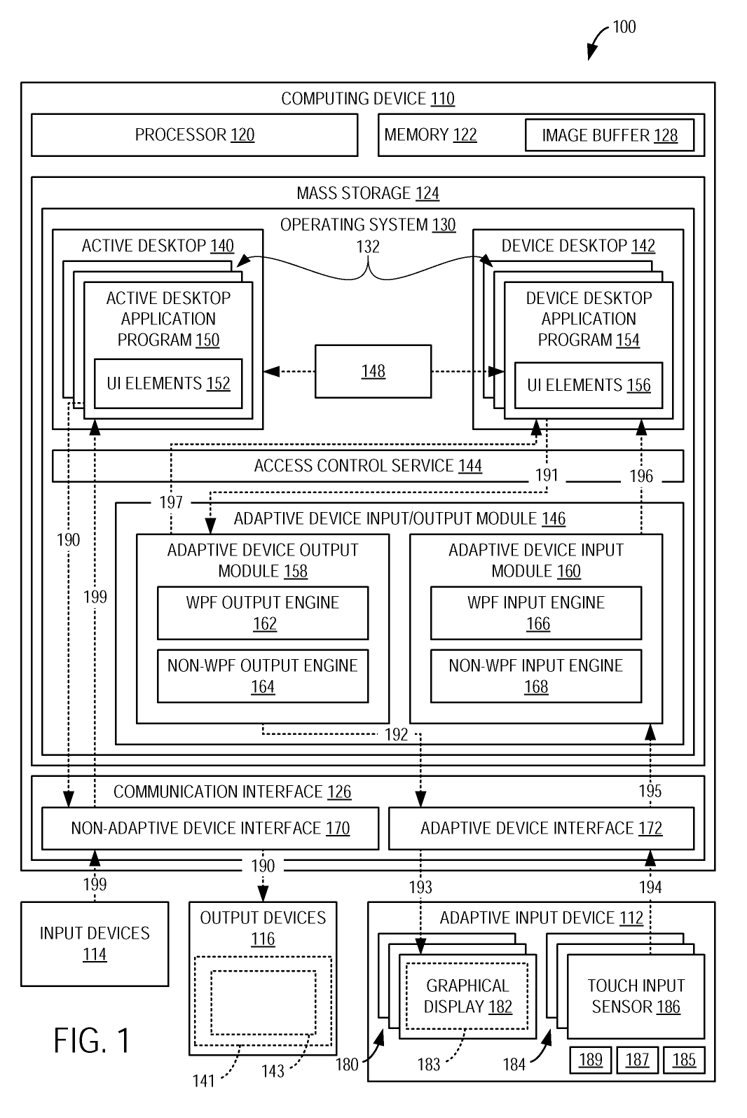

FIG. 1 is a schematic depiction of an example embodiment of a computing system 100. Computing system 100 includes a computing device 110 and an adaptive input device 112. Additionally, computing system 100 may further include one or more input devices 114 (e.g., a keyboard, a mouse, a touch-sensitive graphical display, a microphone, etc.) and one or more output devices 116 (e.g., a monitor, a touch-sensitive graphical display, etc.).

Computing device 110 may include one or more of a processor 120, memory 122, mass storage 124, and a communication interface 126. In the embodiment of FIG. 1, computing device 110 is configured to facilitate communication between adaptive input device 112 and one or more device desktop application programs such as device desktop application program 154.

Mass storage 124 of computing device 110 may be configured to hold instructions that are executable by processor 120, including operating system 130 and application programs 132. Operating system 130 may include one or more of an active desktop 140, a device desktop 142, an access control service 144, and an adaptive device input/output module 146. Active desktop 140 may be configured to host one or more active desktop application programs, including active desktop application program 150. Active desktop 140 may be displayed by one or more of output devices 116 as indicated at 141.

In at least some embodiments, device desktop 142 (i.e., device desktop 142) may be managed by operating system 130 executed by processor 120 of computing system 100. Device desktop 142 may be independent from active desktop 140 of operating system 130, and may be configured to be displayed across one or more graphical displays (e.g., graphical display 182) of one or more adaptive input devices (e.g., adaptive input device 112). Device desktop 142 may be configured to receive user input (e.g., touch input) from corresponding touch input sensors (e.g., touch input sensor 186) associated with one or more graphical displays of the one or more adaptive input devices.

Device desktop 142 may be configured to host one or more device desktop application programs, including device desktop application program 154. Hence, device desktop 142 may be configured to host input device user interface 183 of at least one device desktop application program (e.g., device desktop application program 154). In contrast to active desktop 140 which may be displayed by one or more of output devices 116 as indicated at 141, device desktop 142 may not be displayed to the user in some embodiments.

Application programs 132 may include one or more active desktop application programs, such as active desktop application program 150 that are configured to operate on active desktop 140. Active desktop application program 150 may include one or more user interface elements 152 that collectively provide a graphical user interface of active desktop application program 150. Active desktop application program 150 may be configured to present the graphical user interface comprising the one or more user interface elements 152 on active desktop 140 as indicated at 143.

Application programs 132 may further include one or more device desktop application programs, such as device desktop application program 154, which are configured to operate on device desktop 142. Device desktop application program 154 may include one or more user interface elements 156 that collectively provide an input device user interface 183 of device desktop application program 154. Device desktop application program 154 may be configured to present input device user interface 183 comprising the one or more user interface elements via adaptive input device 112.

Active desktop application programs that are hosted at active desktop 140 may communicate with device desktop application programs that are hosted at device desktop 142 via an inter-process communication interface 148. As a non-limiting example, inter-process communication interface 148 may include a named pipe, a socket, or other inter-process communication mechanism. Alternatively, the active desktop 140 and the device desktop 142 may be implemented by a single process and an in-process communication mechanism may be used. In some embodiments, inter-process communication interface 148 may be provided by operating system 130 to facilitate inter-process communication between an active desktop application program and a device desktop application program. As one example, device desktop application program 154 may be configured to transmit data (e.g., based on user input received from adaptive input device 112) to active desktop application program 150 via an inter-process communication interface 148 responsive to receiving user input from adaptive input device 112. Active desktop application program 150 may be configured transmit commands to device desktop application program 154 via inter-process communication interface 148 responsive to receiving the data from device desktop application program 154.

In at least some embodiments, one or more of active desktop application program 150 and device desktop application program 154 are WINDOWS presentation foundation (WPF) type applications, or a platform-independent network-enabled rich client such as SILVERLIGHT. WPF type applications may be defined by a predefined presentation mark-up language that includes an extensible application mark-up language (XAML). XAML is a GUI declarative language that may be used to enable WPF type applications to interact with operating system 130 to present graphical user interface elements on an external device such as one or more of output devices 116 and adaptive input device 112. Furthermore, in at least some embodiments, one or more of active desktop application program 150 and device desktop application program 154 are a WIN32 or a WINFORMS type application.

WPF type applications may be distinguished from WIN32 or WINFORMS type applications by the manner by which they are rendered to a graphical display. In at least some embodiments a WPF type application may be constrained by the operating system to present its user interface elements at a graphical display via a single window handle, whereas WIN32 or WINFORMS type applications may be permitted to present their user interface elements at a graphical display via one or more window handles.

In at least some embodiments, an access control service 144 may be provided that is configured to determine whether device desktop application program 154 is an approved application. As a non-limiting example, access control service 144 may be configured to examine a digital certificate of device desktop application program 154 to determine if the digital certificate has been signed. Such digital signature may be signed by a trusted certification party upon compliance of the device desktop application program with a predefined certification process. If the device desktop application program is an approved application, then access control service 144 may be configured to permit the one or more user interface elements to be displayed at the adaptive input device. If the device desktop application program is not an approved application, then access control service 144 may be configured to prohibit the user interface elements from being displayed at the adaptive input device, and prohibit input from being delivered to the device desktop.

Adaptive device input/output module 146 may include one or more of an adaptive device output module 158 and an adaptive device input module 160. Adaptive device output module 158 may include one or more output engines, such as a WPF output engine 162 and a non-WPF output engine 164. Adaptive device output module 158 may be configured to identify an image rendering protocol of the device desktop application program in the device desktop and create an image of the one or more user interface elements according to the image rendering protocol.

While adaptive device output module 158 is depicted as supporting two display technologies (e.g., image rendering protocols), it will be appreciated that adaptive device output module 158 may be configured to support any suitable number of display technologies. For example, an output engine of adaptive device output module 158 may be configured to support one or more native code, .NET, WINDOWS Presentation Foundation (WPF), SILVERLIGHT, and D3D technologies, among others. Hence, adaptive device output module 158 may include only one output engine or may include three or more different output engines in other embodiments.

Adaptive device input module 160 may include one or more input engines, such as a WPF input engine 166 and a non-WPF input engine 168. It will be appreciated that adaptive device input module 160 may include any suitable number of input engines for supporting device input technologies associated with adaptive input devices. As will be described in the context of input and output commands for adaptive input device 112, adaptive device input/output module 146 may support native application programs of the operating system (e.g., that are WIN32 or a WINFORMS type applications) and non-native application programs (e.g., that are WPF type applications).

In at least some embodiments, adaptive device output module 158 of adaptive device input/output module 146 may be configured to receive an output command 191 from device desktop application program 154. The output command may include the one or more user interface elements 156 of device desktop application program 154. Adaptive device output module 158 of adaptive device input/output module 146 may be further configured to determine whether the output command is formatted according to a predefined presentation mark-up language. As a non-limiting example, adaptive device output module 158 may be configured to determine whether the output command is an XAML command. The presence of XAML in the output command may be used by the adaptive device input/output module to identify whether device desktop application program 154 is a WPF type application.

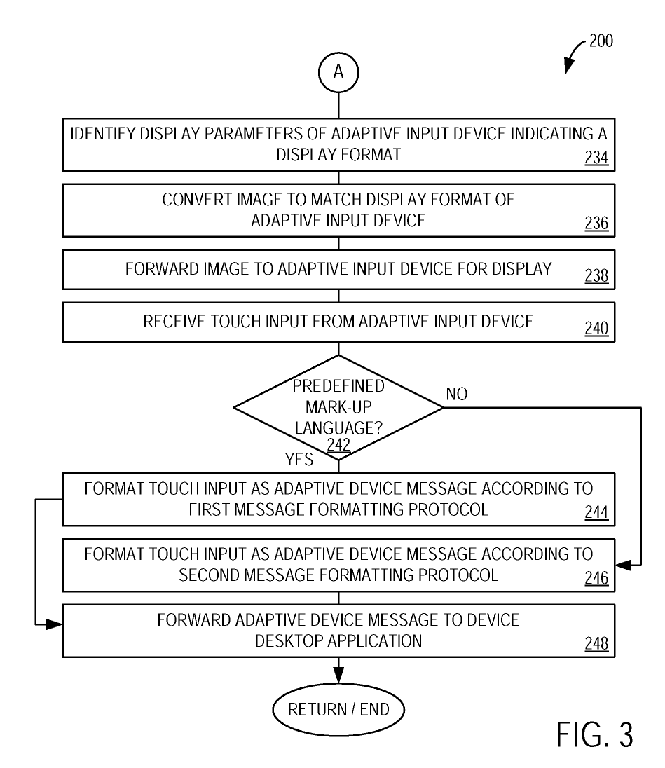

If the output command is formatted according to the predefined presentation mark-up language (e.g., XAML), then adaptive device output module 158 of adaptive device input/output module 146 may be configured to create an image of the one or more user interface elements according to a first image rendering protocol. As a non-limiting example, WPF output engine 162 may be configured to create the image of the one or more user interface elements according to the first image render protocol (e.g., if the output command is formatted according to XAML). The first image rendering protocol is described in greater detail with reference to method 400 of FIG. 4.

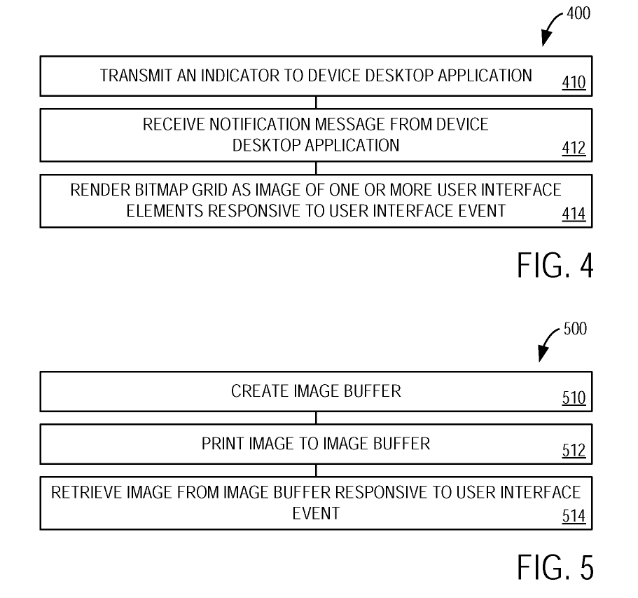

If the output command is not formatted according to the predefined presentation mark-up language, then adaptive device output module 158 of adaptive device input/output module 146 may be configured create an image of the one or more user interface elements according to a second image rendering protocol. As a non-limiting example, non-WPF output engine 164 may be configured to create the image of the one or more user interface elements according to the second image rendering protocol (e.g., if the output command is not formatted according to XAML). The second image rendering protocol is described in greater detail with reference to method 500 of FIG. 5.

Adaptive device input/output module 146 may be configured to forward the image that is created by WPF output engine 162 or non-WPF output engine 164 to adaptive input device 112 for display as indicated at 192 and 193. Communication interface 126 may include a non-adaptive device interface 170 and an adaptive device interface 172. Adaptive device interface 172 may be configured to operatively couple one or more adaptive input devices, including adaptive input device 112 having a graphical display system for displaying graphical content and a touch input system for receiving user input to processor 120.

Non-adaptive device interface 170 may be configured to operatively couple one or more input devices 114 and one or more output devices 116 to processor 120. For example, user input may be directed from input devices 114 to active desktop application program 150 via non-adaptive device interface 170 as indicated at 199 and output may be direct from active desktop application program 150 to output devices 116 as indicated at 190.

Adaptive input device 112 may include a graphical display system 180, including one or more graphical displays, such as graphical display 182. Adaptive input device 112 may include an input system 184, including one or more touch input sensors, such as touch input sensor 186. Touch input sensor 186 may be configured to facilitate reception of user input via a mechanical depressible button or a touch-sensitive graphical display. For example, touch input sensor 186 may include one more of an optical sensor or an electrical sensor for receiving touch input. As a non-limiting example, where graphical display 182 is a capacitive or resistive based touch-sensitive display, touch input sensor 186 may include an electrical sensor that is configured to detect changes in capacitance or resistance of graphical display 182. As another example, where graphical display 182 is an optical touch-sensitive display, touch input sensor 186 may include an optical sensor that is configured to detect changes to the infrared field at or around graphical display 182.

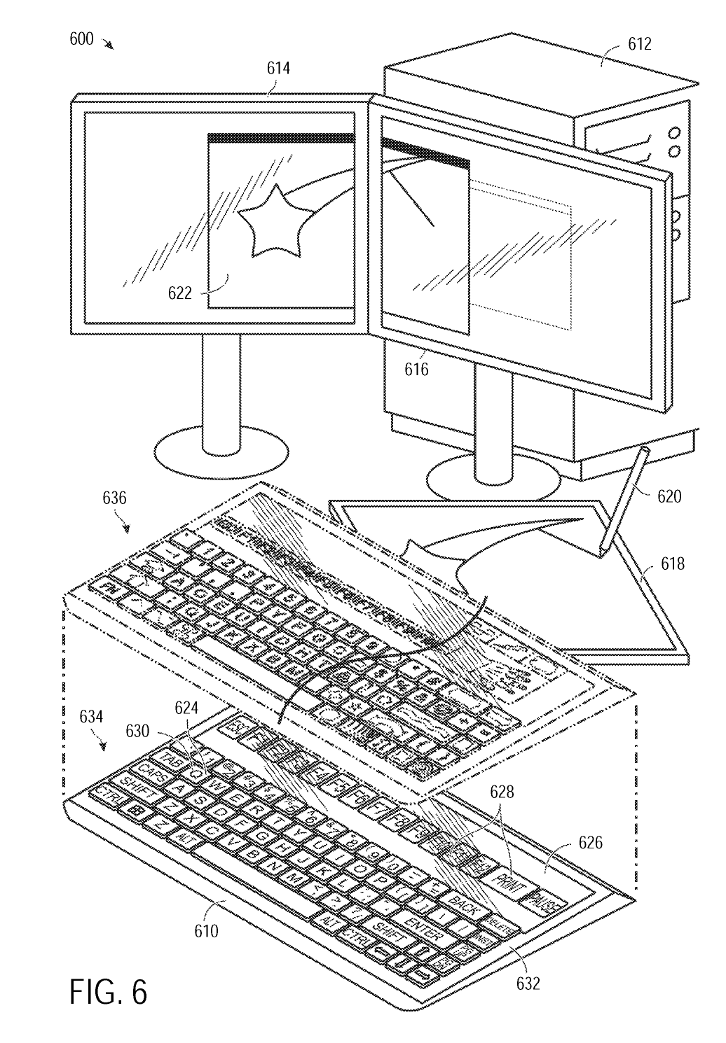

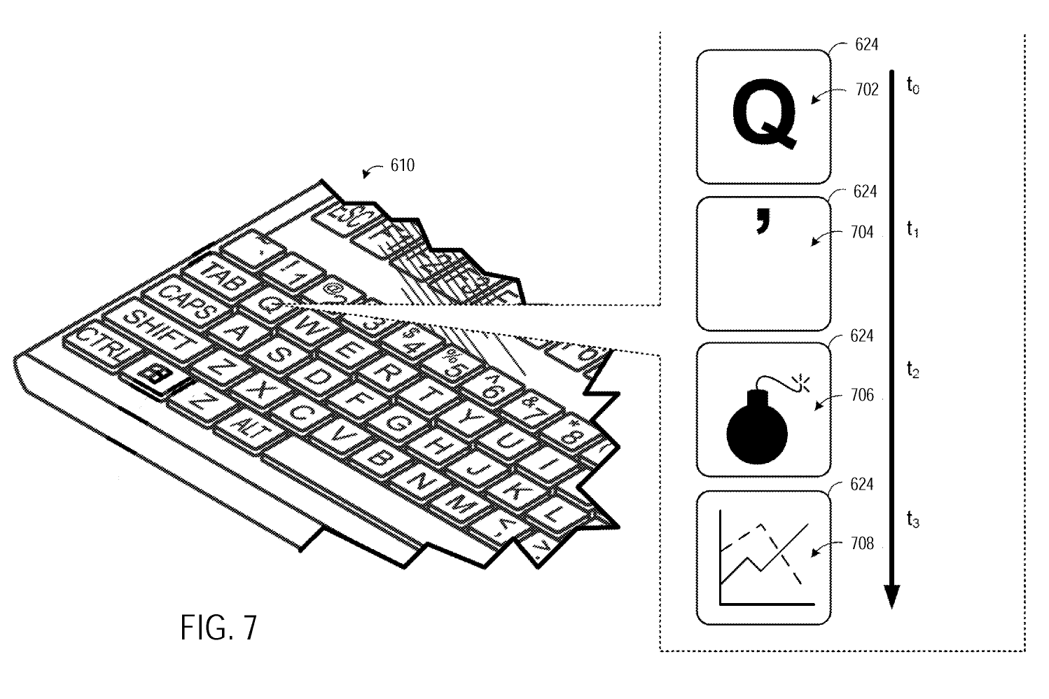

In at least some embodiments, touch input system 184 of adaptive input device 112 may include at least one mechanical depressible button for receiving touch input, where graphical display 182 may be disposed on the mechanical depressible button for presenting the one or more user interface elements of the device desktop application program. A non-limiting example of adaptive input device 112 is provided in FIGS. 6 and 7 with respect to adaptive input device 610.

Furthermore, it should be appreciated that adaptive input device 112 may be configured to receive non-touch input in the form of voice input (e.g., for accommodating voice recognition commands) or other auditory commands via a microphone 185. Further, the adaptive input device 112 may be configured to receive other non-touch input in the form of three dimensional gestures using one or more charge coupled device (CCD) cameras 187 or other three dimensional image sensors. Further, the adaptive input device 112 may be configured to receive non-touch input in the form of a presence indicator from a presence sensor 189 that detects the presence of a user in a vicinity of the adaptive input device, for example, using an infrared sensor. Once received at the adaptive input device 112, these forms of non-touch input may be processed in a similar manner as touch input, as described below. It will be appreciated that in other embodiments, microphone 185, three dimensional gesture cameras 187, and/or presence sensor 189 may be omitted.

In at least some embodiments, the adaptive device input/output module is further configured to receive touch input from adaptive input device 112 as indicated at 194 and 195. If the output command of the device desktop application program is formatted according to the predefined presentation mark-up language, then WPF input engine 166 of adaptive device input/output module 146 may be configured to format the touch input as an adaptive input device message according to a first message formatting protocol. In at least some embodiments, formatting the touch input according to the first message formatting protocol may include redirecting the touch input from adaptive device input module 160 to device desktop application program 154 as indicated at 196, and forwarding the touch input on to the active desktop application 150, via the interprocess communication interface 148.

Alternatively, if the output command of the device desktop application program is not formatted according to the predefined presentation mark-up language, then non-WPF input engine 168 of adaptive device input/output module 146 may be configured to format the touch input as an adaptive input device message according to a second message formatting protocol. In at least some embodiments, non-WPF input engine 168 may include a touch input digitizer for converting signals received from touch input sensor 186 to a format that is suitable for device desktop application program 154. Adaptive device input module 160 may be then configured to forward the adaptive input device message to device desktop application program 154 as indicated at 196. In at least some embodiments, formatting the touch input according to the second message formatting protocol may include converting the touch input to WINDOWS messages (e.g., via the touch input digitizer of non-WPF input engine 168) before forwarding the adaptive input device message to device desktop application program 154.

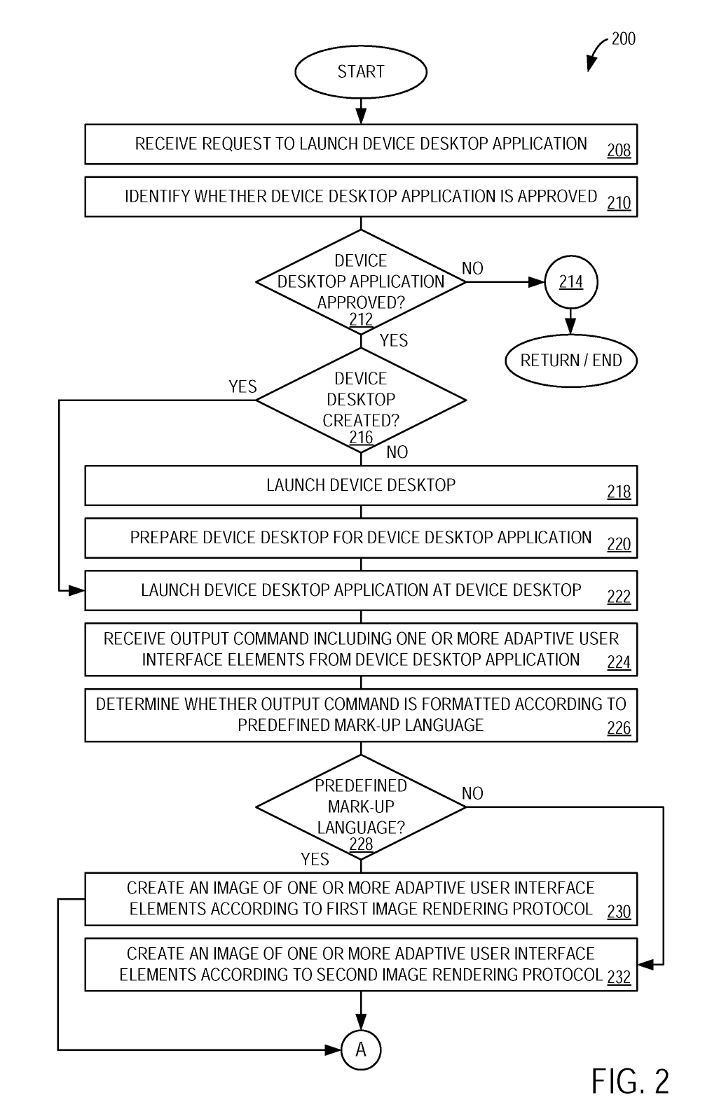

FIGS. 2 and 3 are flowcharts depicting an example embodiment of a method 200 of facilitating communication between an adaptive input device and a device desktop application program managed by an operating system of a computing device. As a non-limiting example, method 200 may be performed by operating system 130 of FIG. 1.

Referring specifically to FIG. 2, at 208, method 200 includes receiving a request to launch a device desktop application program. In at least some embodiments, a request to launch one or more of an active desktop application program (e.g., active desktop application program 150) and a device desktop application program (e.g., device desktop application program 154), may be initiated by a user of the computing system. In at least some embodiments, the active desktop application program may serve as a parent application of an associated device desktop application program, where the active desktop application program may be configured to initiate the request to launch the associated device desktop application program.

At 210, method 200 includes identifying whether the device desktop application program is an approved application that is qualified to run at the computing system. As a non-limiting example, an access control service (e.g., access control service 144) may be configured to examine a digital certificate of the device desktop application program and judge that the device desktop application program is approved if the digital certificate includes a suitable digital signature.

If the device desktop application program is an approved application, then the method may include permitting the one or more user interface elements to be presented at the adaptive input device by proceeding to 216. Alternatively, if the device desktop application program is not an approved application program, then the method may include prohibiting the user interface elements from being presented at the adaptive input device, and also prohibiting touch input and non-touch input from being delivered to the device desktop from the adaptive input device.

For example, if at 212, the device desktop application program is judged not to be an approved application, the process flow of method 200 may proceed to 214. At 214, the device desktop application program may be prevented from launching by the access control service. In at least some embodiments, the operating system may prompt the user to approve the application. If the user approves the application at 214, then the process flow of method 200 may return to 212 where the answer may be instead judged yes. If at 212, the device desktop application program is judged to be an approved application, then at 216, method 200 includes judging whether a device desktop (e.g., device desktop 142) for hosting the device desktop application program has been created. If the device desktop has not yet been created, then at 218, method 200 includes launching the device desktop (e.g., device desktop 142).

At 220, method 200 includes preparing the device desktop for a device desktop application program. In at least some embodiments, preparing the device desktop may include setting a hook at the device desktop that enables the adaptive device input/output module to communicate with the device desktop application program. The hook may be used by the operating system to obtain the input device user interface of the device desktop application program that may be presented at the adaptive input device.

If the answer at 216 is judged yes (i.e., the device desktop has been created) or from 220, the process flow of method 200 may proceed to 222. At 222, method 200 includes launching the device desktop application program at the device desktop. Launching the device desktop application at the device desktop may include initiating or creating a process for the device desktop application at the device desktop.

At 224, method 200 includes receiving an output command from the device desktop application program. In at least some embodiments, the output command includes one or more user interface elements (e.g., user interface elements 156) of an input device user interface of the device desktop application program. The output command may further include instructions for presenting the one or more user interface elements of the input device user interface. The output command may be received at an adaptive device output module (e.g., adaptive device output module 158) of an adaptive device input/output module (e.g., adaptive device input/output module 146).

In at least some embodiments, the device desktop application program may be configured to output the output command in response to a user interface event. A user interface event may be generated by the device desktop application program responsive to one or more of user input that is received at the device desktop application program and commands that are received from an active desktop application program (e.g., via inter-process communication interface 148) in order to change or update the input device user interface of the device desktop application program.

Method 200 may further include identifying an image rendering protocol of the device desktop application program in the device desktop. For example, at 226, method 200 includes determining whether the output command is formatted according to the predefined presentation mark-up language. In at least some embodiments, the predefined presentation mark-up language is XAML, for example, where the device desktop application program is a WPF type application. As a non-limiting example, the adaptive device output module that receives the output command from the device desktop application program may be configured to determine whether the output command is formatted according to the predefined presentation mark-up language.

Method 200 may further include creating an image of the one or more user interface elements according to the image rendering protocol. For example, at 228, if the output command is formatted according to the pre-defined mark-up language (e.g., XAML), then at 230, method 200 includes creating an image of the one or more user interface elements according to a first image rendering protocol. In at least some embodiments, a WPF output engine (e.g., WPF output engine 162) may be configured to create the image of the one or more user interface elements according to the first image rendering protocol if the output command is formatted according to XAML. Method 400 of FIG. 4 provides a non-limiting example for creating the image according to the first image rendering protocol.

Alternatively, if at 228 the output command is not formatted according to the predefined presentation mark-up language, then at 232, method 200 includes creating an image of the one or more user interface elements according to a second image rendering protocol. In at least some embodiments, a non-WPF output engine (e.g., non-WPF output engine 164) may be configured to create the image of the one or more user interface elements according to the second image rendering protocol if the output command is not formatted according to the predefined presentation mark-up language. Method 500 of FIG. 5 provides a non-limiting example for creating the image according to the second image rendering protocol.

Referring now to FIG. 3, from either 230 or 232, the process flow may proceed to 234, where method 200 includes identifying display parameters of the adaptive input device. In at least some embodiments, the display parameters indicate a display format of the adaptive input device. At 236, method 200 includes converting the image to match the display format of the adaptive input device. Further, in at least some embodiments, converting the image may further include compressing the image to reduce bandwidth utilized to transmit the image from the computing device to the adaptive input device.

At 238, method 200 includes forwarding the image to the adaptive input device for display. In at least some embodiments, forwarding the image to the adaptive input device may include transmitting the image to the adaptive input device via the adaptive device interface (e.g., adaptive device interface 172). It should be appreciated that any suitable communication protocol may be used for transmitting the image to the adaptive input device, including one or more of USB, Bluetooth, FireWire, etc.

At 240, method 200 may include receiving touch input from the adaptive input device. As a non-limiting example, a touch input may be received at one or more touch-input sensors (e.g., touch input sensor 186) of the adaptive input device, where it may be forwarded to an adaptive device input module (e.g., adaptive device input module 160) via an adaptive device interface (e.g., adaptive device interface 172). It will also be appreciated that non-touch input in the forms described above may also be received from the adaptive device, and processed similarly to the touch input, in the manner described below.

At 242, if it is judged that the output command is formatted according to the pre-defined mark-up language, then at 244, method 200 includes formatting the touch input as an adaptive input device message according to a first message formatting protocol. In at least some embodiments, a WPF input engine (e.g., WPF input engine 166) may be configured to format the touch input as the adaptive input device message according to the first message formatting protocol if the output command is formatted according to the predefined mark-up language (e.g., XAML). XAML may be used by the adaptive device input/output module to indicate that the device desktop application program is a WPF type application.

Alternatively, if at 240 the output command is not formatted according to the predefined presentation mark-up language, then at 246, method 200 includes formatting the touch input as an adaptive input device message according to a second message formatting protocol. In at least some embodiments, a non-WPF input engine (e.g., non-WPF input engine 168) may be configured to format the touch input as the adaptive input device message according to the second message formatting protocol if the output command is not formatted according to the predefined mark-up language. From either 244 or 246, the process flow of method 200 may proceed to 248.

At 248, method 200 includes forwarding the adaptive input device message to the device desktop application program. In at least some embodiments, the adaptive input device message may cause the device desktop application program to generate a user interface event. As one example, the device desktop application program may be configured to forward data that is based on the adaptive input device message to an associated active desktop application program (e.g., via an inter-process communication interface), which may cause the active desktop application program to return a command that causes the device desktop application program to generate the user interface event. From 248, method 200 may return or end.

FIG. 4 is a flowchart depicting an example embodiment of a method 400 for creating an image of one or more user interface elements according to the first image rendering protocol performed at 230 of method 200. In at least some embodiments, method 400 may be performed by the WPF output module of the adaptive device input/output module. At 410, method 400 includes transmitting a user interface change indicator to the device desktop application program, for example, as indicated at 197 in FIG. 1. The device desktop application program may be configured to receive the user interface change indicator and subsequently issue a notification message to the adaptive device input/output module in response to a user interface event of the device desktop application program. The user interface event may include a change or update of the input device user interface of the device desktop application program.

At 412, method 400 includes receiving a notification message from the device desktop application program. In at least some embodiments, the notification message may be received at the WPF output engine of the adaptive device output module. At 414, method 400 includes rendering a bitmap grid as the image of the one or more user interface elements responsive to a user interface event. For example, WPF output engine may be configured to render the bitmap grid as the image of the one or more user interface elements responsive to a user interface event of the device desktop application program as indicated by the notification message.

FIG. 5 is a flowchart depicting an example embodiment of a method 500 for creating an image of one or more user interface elements according to the second image rendering protocol performed at 232 of method 200. In at least some embodiments, method 500 may be performed by the non-WPF output engine of the adaptive device input/output module. At 510, method 500 includes creating an image buffer. For example, the non-WPF output engine may be configured to create a device context for each device desktop application program and a compatible bitmap for the device context. Where multiple device desktop application programs are operating at the device desktop, the image buffer may include multiple device contexts.

At 512, method 500 includes printing the image to the image buffer. For example, the non-WPF output engine may be configured to print the image to image buffer 128 of memory 122 of FIG. 1 by referencing the device context that was created at 510. At 514, method 500 includes retrieving the image from the image buffer responsive to a user interface event. For example, the non-WPF output engine may be configured to retrieve the image from image buffer 128 of memory 122 by transmitting a command that includes the device context for the device desktop application program.

FIG. 6 shows a non-limiting example of an adaptive input device 610 in the context of a computing system 600. The adaptive input device 610 is shown in FIG. 6 connected to a computing device 612, which may be configured to process input received from adaptive input device 610 and to dynamically change an appearance of the adaptive input device 610 in accordance with method 200 of FIG. 2.

Computing system 600 further includes monitor 614 and monitor 616, which provide non-limiting examples of output devices 116 of computing system 100 of FIG. 1. Computing system 600 may further include a peripheral input device 618 receiving user input via a stylus 620 as yet another example of output devices 116. Computing device 612 may process an input received from the peripheral input device 618 and display a corresponding visual output 622 on the monitor(s).

In the embodiment of FIG. 6, adaptive input device 610 includes a plurality of mechanically depressible buttons or keys, such as mechanically depressible key 624, and touch regions, such as touch-sensitive region 626 for displaying virtual controls 628. The adaptive input device may be configured to recognize when a key is pressed or otherwise activated via a touch input sensor as previously described with respect to touch input sensor 186. Similarly, the adaptive input device 610 may be configured to recognize touch input directed to a portion of touch-sensitive region 626.

Each of the mechanically depressible buttons may have a dynamically changeable visual appearance provided by a corresponding graphical display. In particular, a key image 630 may be presented on a key, and such a key image may be adaptively updated by the computing device. A key image may be changed to visually signal a changing functionality of the key, for example.

Similarly, the touch-sensitive region 626 may have a dynamically changeable visual appearance. In particular, various types of touch images may be presented by the touch region, and such touch images may be adaptively updated. As an example, the touch region may be used to visually present one or more different touch images that serve as virtual controls (e.g., virtual buttons, virtual dials, virtual sliders, etc.), each of which may be activated responsive to a touch input directed to that touch image. The number, size, shape, color, and/or other aspects of the touch images can be changed to visually signal changing functionality of the virtual controls. It may be appreciated that one or more depressible keys may include touch regions, as discussed in more detail below.

The adaptive keyboard may also present a background image 632 in an area that is not occupied by key images or touch images. The visual appearance of the background image 632 also may be dynamically updated. The visual appearance of the background may be set to create a desired contrast with the key images and/or the touch images, to create a desired ambiance, to signal a mode of operation, or for virtually any other purpose.

FIG. 6 shows adaptive input device 610 with a first visual appearance 634 in solid lines, and an example second visual appearance 636 of adaptive input device 610 in dashed lines. The visual appearance of different regions of the adaptive input device 610 may be customized based on a large variety of parameters. As further elaborated with reference to FIG. 7, these may include, but not be limited to: active application programs, application program context, system context, application program state changes, system state changes, user settings, application program settings, system settings, etc.

In one example, responsive to a first user interface event of a device desktop application program, the key images (e.g., key image 630) may display a QWERTY keyboard layout. Key images also may be updated with icons, menu items, etc. from the selected application program. Furthermore, the touch-sensitive region 626 may be updated to display virtual controls tailored to controlling the device desktop application program. As an example, at t0, FIG. 7 shows depressible key 624 of adaptive input device 12 visually presenting a Q-image 702 of a QWERTY keyboard. At t1, FIG. 7 shows the depressible key 624 after it has dynamically changed to visually present an apostrophe-image 704 of a Dvorak keyboard in the same position that Q-image 702 was previously displayed.

In another example, responsive to a user interface event of the device desktop application program, the depressible keys and/or touch region may be updated to display gaming controls. For example, at t2, FIG. 7 shows depressible key 624 after it has dynamically changed to visually present a bomb-image 706. As still another example, responsive to yet another user interface event of the device desktop application program, the depressible keys and/or touch region may be updated to display graphing controls. For example, at t3, FIG. 7 shows depressible key 624 after it has dynamically changed to visually present a line-plot-image 708. As illustrated in FIG. 7, the adaptive input device 610 dynamically changes to offer the user input options relevant to the device desktop application program.

While the above described embodiments have been illustrated as being provided with a touch input sensor 186 configured to receive touch input at the adaptive input device 112, it will be appreciated that other embodiments are possible in which touch input sensor 186 is omitted and only non-touch input sensors, such as microphone 185, three dimensional gesture cameras 187, and/or presence sensors 189 are provided. The non-touch input received from these non-touch input sensors may be processed in a manner similar to that described above for touch input.

It will be appreciated that the computing device described herein may be any suitable computing device configured to execute the programs described herein. For example, the computing device may be a mainframe computer, personal computer, laptop computer, portable data assistant (PDA), computer-enabled wireless telephone, networked computing device, or other suitable computing device, and may be connected to other computing devices via computer networks, such as the Internet. These computing devices typically include a processor and associated volatile and non-volatile memory, and are configured to execute programs stored in non-volatile memory using portions of volatile memory and the processor. As used herein, the term “program” refers to software or firmware components that may be executed by, or utilized by, one or more computing devices described herein, and is meant to encompass individual or groups of executable files, data files, libraries, drivers, scripts, database records, etc. It will be appreciated that computer-readable media may be provided having program instructions stored thereon, which upon execution by a computing device, cause the computing device to execute the methods described above and cause operation of the systems described above.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A computing system, comprising:
a device desktop managed by an operating system executed by a processor of the computing system, the device desktop being independent from an active desktop of the operating system, and being configured to be displayed across one or more displays of one or more adaptive input devices, and configured to receive user input from corresponding touch input sensors associated with the one or more displays of the one or more adaptive input devices, the device desktop being configured to host an input device user interface of at least one device desktop application program;
an adaptive device input/output module configured to:
receive an output command from the device desktop application program, the output command including instructions for presenting one or more user interface elements of the input device user interface;
identify an image rendering protocol of the device desktop application program in the device desktop;
create an image of the one or more user interface elements according to the image rendering protocol; and
forward the image to the adaptive input device for display.

2. The computing system of claim 1, where the adaptive device input/output module is further configured to:
prepare the device desktop for the device desktop application program by setting a hook at the device desktop based on the image rendering protocol identified for the device desktop application program, the hook enabling the adaptive device input/output module to communicate with the device desktop application program.

3. The computing system of claim 1, where the adaptive device input/output module is further configured to:
determine whether the output command is formatted according to a predefined presentation mark-up language;
if the output command is formatted according to the predefined presentation mark-up language, then create an image of the one or more adaptive user interface elements according to a first image rendering protocol; and
if the output command is not formatted according to the predefined presentation mark-up language, then create an image of the one or more adaptive user interface elements according to a second image rendering protocol.

4. The computing system of claim 3, where the predefined presentation mark-up language is an extensible application mark-up language (XAML); and
where the adaptive device input/output module, in creating the image according to the first image rendering protocol is configured to:
transmit a user interface change indicator to the device desktop application program, the user interface change indicator configured to cause the device desktop application program to transmit a notification message to the adaptive device input/output module responsive to a user interface event; and
in response to receiving the notification message from the device desktop application program, render a bitmap grid as the image of the one or more user interface elements to be forwarded to the adaptive input device for display.

5. The computing system of claim 3,
where the adaptive device input/output module, in creating the image according to the second image rendering protocol is configured to:
create an image buffer;
print the image to the image buffer; and
retrieve the image from the image buffer, which is responsive to a user interface event, to be forwarded to the adaptive input device for display.

6. The computing system of claim 3, where the adaptive device input/output module is further configured to receive touch input from the adaptive input device;
if the output command is formatted according to the predefined presentation mark-up language, then the adaptive device input/output module is configured to format the touch input as an adaptive input device message according to a first message formatting protocol;
if the output command is not formatted according to the predefined presentation mark-up language, then the adaptive device input/output module is configured to format the touch input as an adaptive input device message according to a second message formatting protocol; and
forward the adaptive input device message to the device desktop application program.

7. The computing system of claim 1, further including the adaptive input device;
wherein the touch input system of the adaptive input device includes at least one mechanical depressible button for receiving the touch input; and
wherein the graphical display system of the adaptive input device includes a graphical display disposed on the mechanical depressible button for presenting the one or more user interface elements of the device desktop application program.

8. The computing system of claim 8, further comprising an access control service configured to:
determine whether the hidden desktop application is an approved application;
if the hidden desktop application is an approved application, then permit the one or more adaptive user interface elements to be displayed at the adaptive input device; and
if the hidden desktop application is not an approved application, then prohibit the adaptive user interface elements from being displayed at the adaptive input device.

9. The computing system of claim 1, where the device desktop is further configured to receive from the adaptive input device non-touch input in the form of voice input via a microphone, three dimensional gestures from a three dimensional image sensor, and/or a presence indicator from a presence sensor that detects a presence of a user in a vicinity of the adaptive input device.

10. A method of facilitating communication between an adaptive input device and a device desktop application program managed by an operating system of a computing device, the method comprising:
receiving an output command from the device desktop application program, the output command including one or more user interface elements of an input device user interface;
if the output command is formatted according to a predefined presentation mark-up language, then creating an image of the one or more user interface elements according to a first image rendering protocol;
if the output command is not formatted according to the predefined presentation mark-up language, then creating an image of the one or more user interface elements according to a second image rendering protocol; and
forwarding the image to the adaptive input device for display.

11. The method of claim 10, further comprising, determining whether the output command is formatted according to the predefined presentation mark-up language.

12. The method of claim 10, where the predefined presentation mark-up language is an extensible application mark-up language (XAML); and
where creating the image according to the first image rendering protocol comprises:
transmitting a user interface change indicator to the device desktop application program, the user interface change indicator configured to cause the device desktop application program to transmit a notification message responsive to a user interface event;
receiving the notification message from the device desktop application program; and
in response to receiving the notification message, rendering a bitmap grid as the image of the one or more user interface elements to be forwarded to the adaptive input device for display.

13. The method of claim 12, where creating the image according to the second image rendering protocol comprises:
creating an image buffer;
printing the image to the image buffer; and
retrieving the image from the image buffer, which is responsive to a user interface event to be forwarded to the adaptive input device for display.

14. The method of claim 10, further comprising:
receiving a touch input from the adaptive input device;
if the output command is formatted according to the predefined presentation mark-up language, then formatting the touch input as an adaptive input device message according to a first message formatting protocol;
if the output command is not formatted according to the predefined presentation mark-up language, then formatting the touch input as an adaptive input device message according to a second message formatting protocol; and
forwarding the adaptive input device message to the device desktop application program.

15. The method of claim 10, further comprising:
launching a device desktop for hosting the device desktop application program; and
preparing the device desktop for the device desktop application program by setting a hook at the device desktop that enables communication with the device desktop application program.

16. The method of claim 15, further comprising:
identifying whether the device desktop application program is an approved application;
if the device desktop application program is an approved application, then permitting the one or more user interface elements to be presented at the adaptive input device; and
if the device desktop application program is not an approved application, then prohibiting the user interface elements from being presented at the adaptive input device.

17. The method of claim 10, further comprising:
identifying display parameters of the adaptive input device, the display parameters indicating a display format of the adaptive input device; and
converting the image to match the display format of the adaptive input device before forwarding the image to the adaptive input device for display.

18. A method of facilitating communication between an application program and an adaptive input device, the method comprising:
receiving an output command from the device desktop application program operating at a device desktop, the output command including one or more user interface elements of an input device user interface;
determining whether the output command is formatted according to an extensible application mark-up language (XAML);
if the output command is formatted according to XAML, then creating an image of the one or more user interface elements by:
transmitting a user interface change indicator to the device desktop application program, the user interface change indicator configured to cause the device desktop application program to transmit a notification message responsive to a user interface event;
receiving the notification message from the device desktop application program; and
in response to receiving the notification message, rendering a bitmap grid as the image of the one or more user interface elements;
if the output command is not formatted according to XAML, then creating an image of the one or more user interface elements by:
creating an image buffer;
printing the image to the image buffer; and
retrieving the image from the image buffer; and
forwarding the image to the adaptive input device for display.

19. The method of claim 18, further comprising:
launching a device desktop for hosting the device desktop application program; and
preparing the device desktop for the device desktop application program by setting a hook at the device desktop that enables communication with the device desktop application program.

20. The method of claim 19, further comprising:
identifying display parameters of the adaptive input device, the display parameters indicating a display format of the adaptive input device; and
converting the image to match the display format of the adaptive input device before forwarding the image to the adaptive input device for presentation.
